(19) United States
(12) Patent Application Publication
(10) Pub. No.: US 2008/0236120 A1
(43) Pub. Date: Oct. 2, 2008

(54) Prefilters for Devices with Air Filter

(76) Inventors: Janet Li, Woodbridge, CT (US); Shaoli Sun, Woodbridge, CT (US)

Correspondence Address: Janet Li, 1886 Litchfield Turnpike, Woodbridge, CT, 06525, US

(21) Appl. No.: 11/693,704

(22) Filed: Mar. 29, 2007

(51) Int. Cl. B32B 3/24; B01D 50/00; B32B 5/18

(52) U.S. Cl. 55/486; 428/612; 428/613

(57) ABSTRACT

Prefilter improves efficiency of cleaning process by preventing clogging of filter with dirt or other particles. The polished surface allows easy removal of dirt with one shake. Prefilter extends life of filter.

### DESCRIPTION

| | | |
|---|---|---|
| 3954621 | May 1976 | Etani et al. |
| 4265647 | May 1981 | Donachiue |
| 5102436 | April 1992 | Grabowski |

### FIELD OF THE INVENTION

This invention relates in general to prefilters of air filters, specifically to filters in bagless vacuum cleaners, air ducts, and similar devices using filters that filter dirt from air.

### BACKGROUND OF THE INVENTION

Filters have been used for decades to help devices such as air ducts and bagless vacuum cleaners function efficiently. Filters are purposely designed to trap dirt more efficiently by having a serrated surface to maximize the filtration surface area and by using static material to attract small particles. Although these characteristics allow filters to trap dirt more effectively, they also make filters clog quickly and become more difficult to clean. Therefore, filters must be changed frequently. Unlike filters, the prefilter is made of polished, smooth, mesh material to prevent the trapping of dirt and to allow easy removal of the dirt. With a few simple shakes, the dirt efficiently slides off of the polished surface. When placed upstream the filter, the prefilter collects dirt before it reaches the filter, therefore preventing the filter from clogging. Because less dirt is caught in the filter, the life of the filter is extended considerably.

### SUMMARY OF THE INVENTION

This prefilter is placed in front of the filter and is made of disposable, polished, mesh material which collects dirt without trapping it, making the removal of dirt easy and prolonging the life of the filter by reducing clogging.

### BRIEF DESCRIPTION OF THE FIGURES

FIG. 1 is a prefilter with an elastic rim for use in bagless vacuum cleaners.

FIG. 2 is a prefilter with a rigid frame for use in air ducts.

### DETAILED DESCRIPTION

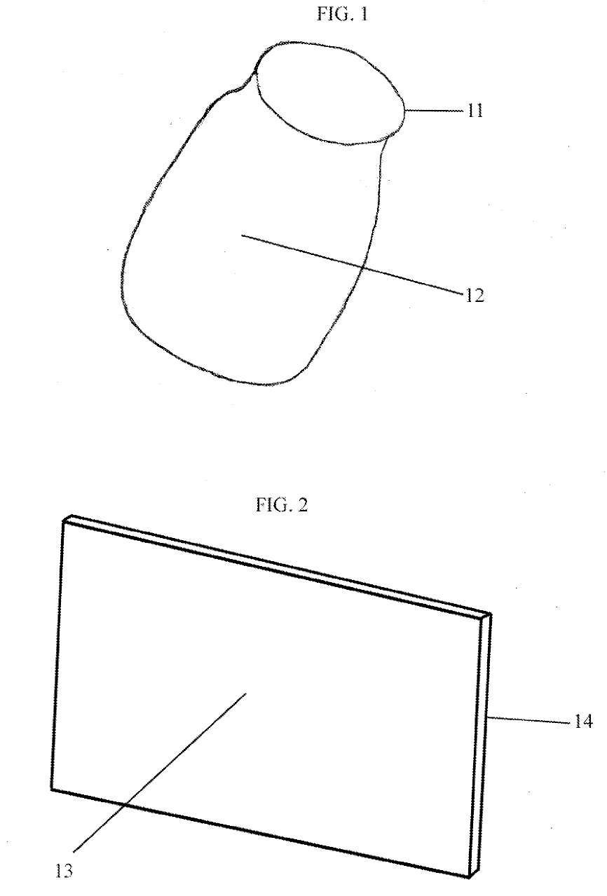

Reference is made to FIG. 1. The prefilter for bagless vacuum cleaners has a sac shape with an elastic rim 11 at the opening. The mesh surface 12 of the prefilter is smooth and polished with pores allowing air to filter through but collecting dirt without trapping it. The elastic rim 11 enables the prefilter to cover the filter perfectly and to keep itself in place during vacuuming. The prefilter thus becomes the first filter that the unpurified air must pass through. The prefilter blocks most of the dirt before it reaches the filter, therefore reducing clogging of the filter and extending the lifetime of the filter. The pore size of the surface 12 must be small enough to block the majority of the dirt but larger than the pore size of the filter in order to keep the vacuuming process ideal. Due to the polished surface 12, the dirt collected during vacuuming slides off easily by gentle shaking. The elastic rim 11 allows the prefilter to cover and be easily attached to the filter of the bagless vacuum cleaner. The elastic rim 11 also enables the prefilter to be easily removed once the prefilter is completely saturated with dirt.

Reference is made to FIG. 2. The prefilter for air duct cleaning systems is flat with a rigid rectangular frame 14. The mesh surface 13 of the prefilter for air ducts is smooth and polished and collects dirt without trapping it. By gently shaking the prefilter after pulling it out from the front of the filter, all of the accumulated dirt on the surface 13 slides off easily; thus, cleaning the dirt accrued on the surface 13 of the prefilter is very convenient. The prefilter has a rigid frame 14 in order to be easily inserted in upstream of the conventional filter of an air duct. During operation, the unpurified air must first go though the prefilter before it reaches the filter, which allows the prefilter to amass most of the dirt. By collecting the majority of the dirt, the prefilter minimizes clogging of the filter and increases the life span of the filter. The pore size of the surface 13 needs to be small enough to collect most of the dirt but large enough to allow air to pass freely during the filtration process. Pore size can be specified according to needs. The prefilter can be cleaned and reused many times until it is completely clogged. At that time it can simply be disposed.

1. Polished surface of prefilter which collects dirt without trapping it, thereby allowing easy removal of collected dirt

2. Position of prefilter in front of filter prevents clogging of filter with dirt, therefore extending life of said filter

3. Said prefilter made of disposable, mesh material with small pores to filter air
